(19) United States
(12) Patent Application Publication
(10) Pub. No.: US 2014/0141782 A1
(43) Pub. Date: May 22, 2014

(54) Methods, Apparatus and Computer Programs for Wireless Devices

(71) Applicant: Broadcom Corporation, Irvine, CA (US)

(72) Inventors: Aki Markus RANTALA, Oulu (FI); Matti Tapani MOISANEN, Oulu (FI); Samuli Antero HEIKKINEN, Oulu (FI)

(73) Assignee: Broadcom Corporation, Irvine, CA (US)

(21) Appl. No.: 14/080,019

(22) Filed: Nov. 14, 2013

(30) Foreign Application Priority Data
Nov. 16, 2012 (GB) 1220693.4

(51) Int. Cl. H04W 36/00

(52) U.S. Cl. CPC H04W 36/0011
USPC 455/436

(57) ABSTRACT

Methods, apparatus and computer programs for changing a communication device from communicating with a first data communication system to a second system are provided. A change in the device's capabilities from a first to a second set is determined. A first message is sent to one system comprising one of the sets, and a second message is sent to a different system and/or comprising a different set, relative to the first message. The first message may comprise a detach request to the first system; the second message may comprise an attach request to the second system. The first and/or second messages may comprise an update request. Methods may comprise sending an update request, receiving a rejection, and sending the first message if the cause is among a predetermined group. One set may include radio technologies (e.g., LTE) not in the other set. Embodiments include apparatus and computer programs and computer-readable media embodying one or more of the methods.

### CROSS REFERENCE TO RELATED APPLICATION

This application claims the benefit under 35 U.S.C. §119 and 37 CFR §1.55 to UK patent application no. 1220693.4, filed on Nov. 16, 2012, the entire content of which is incorporated herein by reference.

### TECHNICAL FIELD

The present invention relates to methods, apparatus and computer programs for wireless devices. The disclosure herein relates generally to the field of wireless or cellular communications, and more particularly to methods, devices, and network equipment supporting multiple packet data communication systems and multiple radio access technologies.

### BACKGROUND

The Third Generation Partnership Project (3GPP) unites six telecommunications standards bodies, known as “Organizational Partners,” and provides their members with a stable environment to produce the highly successful Reports and Specifications that define 3GPP technologies. These technologies are constantly evolving through what have become known as “generations” of commercial cellular/mobile systems. 3GPP also uses a system of parallel “releases” to provide developers with a stable platform for implementation and to allow for the addition of new features required by the market. Each release includes specific functionality and features that are specified in detail by the version of the 3GPP standards associated with that release.

Universal Mobile Telecommunication System (UMTS) is an umbrella term for the third generation (3G) radio technologies developed within 3GPP and initially standardized in Release 4 and Release 99, which preceded Release 4. UMTS includes specifications for both the UMTS Terrestrial Radio Access Network (UTRAN) as well as the Core Network. UTRAN includes the original Wideband CDMA (W-CDMA) radio access technology that uses paired or unpaired 5-MHz channels, initially within frequency bands near 2 GHz but subsequently expanded into other licensed frequency bands. The UTRAN generally includes node-Bs (NBs) and radio network controllers (RNCs). Similarly, GSM/EDGE is an umbrella term for the second-generation (2G) radio technologies initially developed within the European Telecommunication Standards Institute (ETSI) but now further developed and maintained by 3GPP. The GSM/EDGE Radio Access Network (GERAN) generally comprises base stations (BTSs) and base station controllers (BSCs).

Long Term Evolution (LTE) is another umbrella term for so-called fourth-generation (4G) radio access technologies developed within 3GPP and initially standardized in Releases 8 and 9, also known as Evolved UTRAN (E-UTRAN). As with UMTS, LTE is targeted at various licensed frequency bands, including the 700-MHz band in the United States. LTE is accompanied by improvements to non-radio aspects commonly referred to as System Architecture Evolution (SAE) or Evolved Packet Subsystem (EPS), which includes Evolved Packet Core (EPC) network. LTE continues to evolve through subsequent releases. One of the features under consideration for Release 11 is an enhanced Physical Downlink Control Channel (ePDCCH), which has the goals of increasing capacity and improving spatial reuse of control channel resources, improving inter-cell interference coordination (ICIC), and supporting antenna beamforming and/or transmit diversity for control channel.

### SUMMARY

In a first exemplary embodiment of the invention, there is a method for changing a communication device from communicating with a first data communication system to communicating with a second data communication system, comprising determining a change in the device's capabilities from a first set to a second set, such that the device's context in the first data communication system is no longer valid; sending a first message to one of the first and the second data communication systems; and sending a second message that is at least one of the following relative to the first message: directed to a different one of the first and second data communication systems and comprising different device capability information.

In some embodiments, one or more of the first and second messages may be an update request (e.g. routing or tracking area update). In some embodiments, the first message may be a detach request and the second message may be an attach request. One or more embodiments comprise sending a third message. Depending on the embodiment, the capabilities comprising the first set may be a subset of, superset of, or partially overlap with the capabilities comprising the second set. Other embodiments comprise apparatus (e.g. user equipment) and computer programs and computer-readable media with program code embodying one or more of the methods.

There may be provided a method for changing a communication device from communicating with a first data communication system to communicating with a second data communication system, comprising receiving a first message from the device; determining that the first message comprises a second set of capabilities that is different from a first set of capabilities comprising the device's context in the first data communication system; determining that the first message comprises a second set of capabilities that is different from a first set of capabilities comprising the device's context in the first data communication system; sending a second message to the device; removing the device's context in the first communication system; receiving a fourth message from the device comprising the second set of capabilities; and establishing a new context for the device based on the fourth message, wherein the new context allows the device to communicate via the second data communication system.

In some embodiments, the method further comprises receiving a third message comprising a detach request from the device, wherein removing the device's context is performed in response to receiving the third message. In some embodiments, the second message comprises a rejection and information identifying the change in the device's capabilities from the first set to the second set as the rejection cause, and the fourth message comprises an attach request. In some embodiments, the second message comprises a detach request; the fourth message comprises an attach request; and removing the device's context is performed in association with sending the second message. Embodiments include apparatus (e.g. network equipment) and computer programs and a computer-readable medium with program code embodying one or more of these methods.

In a second exemplary embodiment of the invention, there is apparatus comprising: at least one processor; and at least one memory including computer program code; the at least one memory and the computer program code being configured to, with the at least one processor, cause the apparatus at least to: determine a change in the apparatus capabilities from a first set to a second set, such that the apparatus context in a first data communication system is no longer valid; send a first message to one of the first data communication system and a second data communication systems; and send a second message, wherein the second message is at least one of the following relative to the first message: directed to a different one of the first and second data communication systems, and comprising different device capability information.

In a third exemplary embodiment of the invention, there is apparatus comprising: at least one processor; and at least one memory including computer program code; the at least one memory and the computer program code being configured to, with the at least one processor, cause the apparatus at least to: receive a first message from a communication device; determine that the first message comprises a second set of the device's capabilities that is different from a first set of the device's capabilities comprising the device's context in a first data communication system; send a second message to the device; remove the device's context in the first communication system; receive a fourth message from the device comprising the second set of capabilities; and establish a new context for the device based on the fourth message, wherein the new context allows the device to communicate via a second data communication system.

The apparatus referred to above may comprise a transmitter and a receiver.

There may be provided a computer program comprising a set of instructions which, when executed by a processing system of an apparatus, causes the apparatus to: determine a change in the apparatus capabilities from a first set to a second set, such that the apparatus context in a first data communication system is no longer valid; send a first message to one of the first data communication system and a second data communication systems; and send a second message, wherein the second message is at least one of the following relative to the first message: directed to a different one of the first and second data communication systems, and comprising different device capability information.

There may be provided a computer program comprising a set of instructions which, when executed by a processing system of an apparatus, causes the apparatus to: receive a first message from a communication device; determine that the first message comprises a second set of the device's capabilities that is different from a first set of the device's capabilities comprising the device's context in a first data communication system; send a second message to the device; remove the device's context in the first data communication system; receive a fourth message from the device comprising the second set of capabilities; and establish a new context for the device based on the fourth message, wherein the new context allows the device to communicate via a second data communication system.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a high-level block diagram of the architecture of the Long Term Evolution (LTE) Evolved UTRAN (E-UTRAN) and Evolved Packet Core (EPC) network, as standardized by 3GPP;

FIG. 2A is a high-level block diagram of the E-UTRAN architecture in terms of its constituent components, protocols, and interfaces;

FIG. 2B is a block diagram of the protocol layers of the control-plane portion of the radio interface (LTE-Uu) between a user equipment (UE) and the E-UTRAN;

FIG. 3 is a high-level block diagram illustrating the interworking between a UE supporting multiple radio access technologies (RATs), various types of 3GPP radio access networks, and the packet data communication functionality in 3GPP core networks;

FIG. 4 is a flowchart of an exemplary method in an apparatus, such as a communication device, according to one or more embodiments of the present disclosure;

FIG. 5 is a flowchart of another exemplary method in an apparatus, such as a communication device, according to one or more embodiments of the present disclosure;

FIG. 6 is a flowchart of another exemplary method in an apparatus, such as a communication device, according to one or more embodiments of the present disclosure;

FIG. 7 is a flowchart of another exemplary method in an apparatus, such as a communication device, according to one or more embodiments of the present disclosure;

FIG. 8 is a flowchart of another exemplary method in an apparatus, such as a communication device, according to one or more embodiments of the present disclosure;

FIG. 9 is a flowchart of another exemplary method in an apparatus, such as a communication device, according to one or more embodiments of the present disclosure;

FIG. 10 is a flowchart of an exemplary method in a network, according to one or more embodiments of the present disclosure;

FIG. 11 is a block diagram of an exemplary apparatus, such as a user equipment or portion thereof, according to one or more embodiments of the present disclosure; and

FIG. 12 is a block diagram of an exemplary apparatus, such as a network equipment, according to one or more embodiments of the present disclosure.

### DETAILED DESCRIPTION

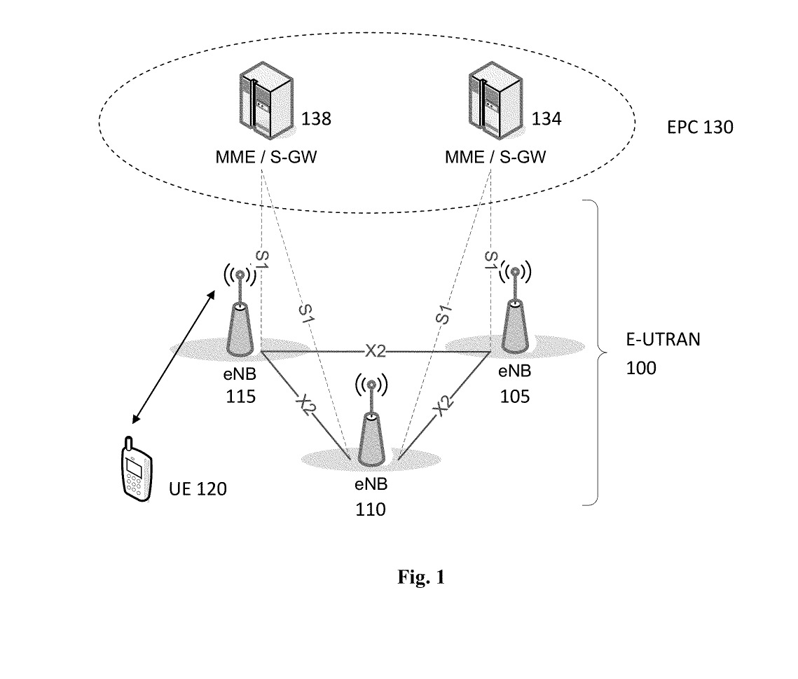

The overall architecture of a network comprising LTE and SAE is shown in FIG. 1. E-UTRAN 100 comprises one or more evolved Node Bs (eNB), such as eNBs 105, 110, and 115, and one or more user equipment (UE), such as UE 120. As used within the 3GPP standards, “user equipment” or “UE” means any wireless communication device (e.g. smartphone or computing device) that is capable of communicating with 3GPP-standard-compliant network equipment, such as UTRAN, E-UTRAN, and/or GERAN, as the second-generation (“2G”) 3GPP radio access network is commonly known.

As specified by 3GPP, E-UTRAN 100 is responsible for all radio-related functions in the network, including radio bearer control, radio admission control, radio mobility control, scheduling, and dynamic allocation of resources to UEs in uplink and downlink, as well as security of the communications with the UE. These functions reside in the eNBs, such as eNBs 105, 110, and 115. The eNBs in the E-UTRAN communicate with each other via the X1 interface, as shown in FIG. 1A. The eNBs also are responsible for the E-UTRAN interface to the EPC, specifically the S1 interface to the Mobility Management Entity (MME) and the Serving Gateway (SGW), shown collectively as MME/S-GWs 134 and 138 in FIG. 1A. Generally speaking, the MME/S-GW handles both the overall control of the UE and data flow between the UE and the rest of the EPC. More specifically, the MME processes the signaling protocols between the UE and the EPC, which are known as the Non Access Stratum (NAS) protocols. The S-GW handles all Internet Protocol (IP) data packets between the UE and the EPC, and serves as the local mobility anchor for the data bearers when the UE moves between eNBs, such as eNBs 105, 110, and 115.

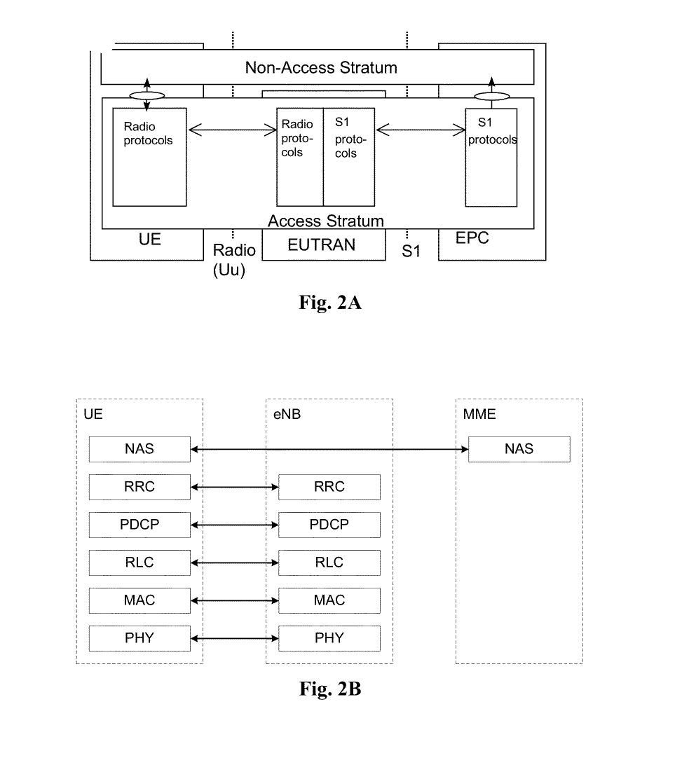

FIG. 2A is a high-level block diagram of LTE architecture in terms of its constituent entities (UE, E-UTRAN, and EPC) and high-level functional division into the Access Stratum (AS) and the Non-Access Stratum (NAS). FIG. 1 also illustrates two particular interface points, namely Uu (UE/E-UTRAN Radio Interface) and S1 (E-UTRAN/EPC interface), each using a specific set of protocols, i.e. Radio Protocols and S1 Protocols. Each of the two protocols can be further segmented into user plane (or “U-plane”) and control plane (or “C-plane”) protocol functionality. On the Uu interface, the U-plane carries user information (e.g., data packets) while the C-plane is carries control information between UE and E-UTRAN.

FIG. 2B is a block diagram of the C-plane protocol stack on the Uu interface comprising Physical (PHY), Medium Access Control (MAC), Radio Link Control (RLC), Packet Data Convergence Protocol (PDCP), and Radio Resource Control (RRC) layers. The PHY layer is concerned with how and what characteristics are used to transfer data over transport channels on the LTE radio interface. The MAC layer provides data transfer services on logical channels, maps logical channels to PHY transport channels, and reallocates PHY resources to support these services. The RLC layer provides error detection and/or correction, concatenation, segmentation, and reassembly, reordering of data transferred to or from the upper layers. The PHY, MAC, and RLC layers perform identical functions for both the U-plane and the C-plane. The PDCP layer provides ciphering/deciphering and integrity protection for both U-plane and C-plane, as well as other functions for the U-plane such as header compression.

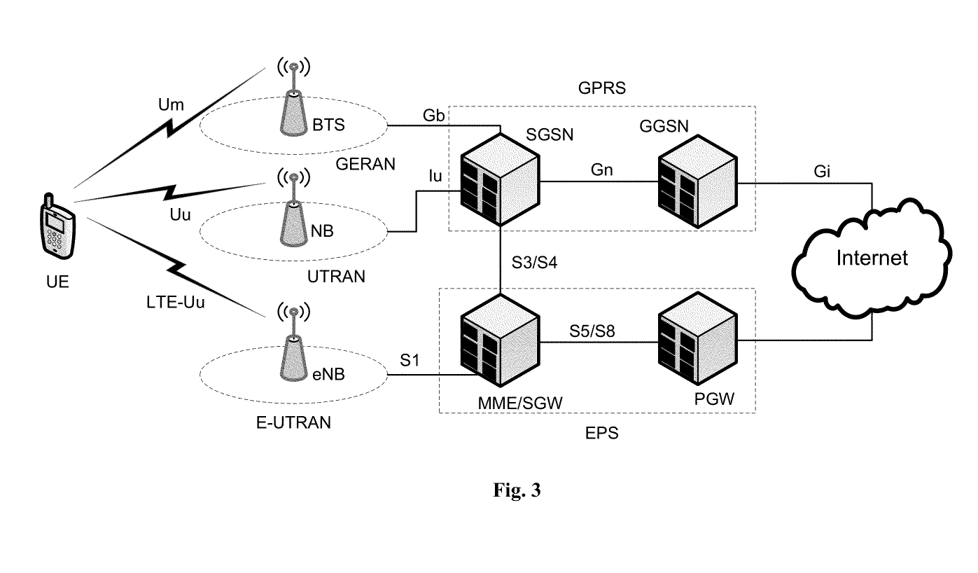

In many cases, a single UE will have capabilities to communicate with multiple types of 3GPP radio access networks, including GERAN, UTRAN, and E-UTRAN. FIG. 3 is a high-level block diagram illustrating the interworking between a UE supporting multiple radio access technologies (RATs), various types of 3GPP radio access networks, and the packet data communication functionality in 3GPP core networks. The UE also is capable of communicating with a GERAN, which comprises one or more BTSs, over the Um interface. The UE is also capable of communicating with a UTRAN, which comprises one or more NBs, over the Uu interface. As discussed above, the UE also is capable of communicating with an E-UTRAN, which comprises one or more eNBs, over the LTE-Uu interface. As shown in FIG. 3, the GERAN, UTRAN, and E-UTRAN may be under common control of a single network operator. In some cases, however, only one of the GERAN and UTRAN will be present in an operator's network.

All packet data communications from the UE via the GERAN and UTRAN pass through the General Packet Radio Service (GPRS) sub-system. The GPRS sub-system comprises a Serving GPRS Support Node, which connects to the GERAN via the Gb interface and to the UTRAN via the Iu interface. The SGSN is responsible for routing of packets to/from the UE and for mobility and data connection management with respect to the UE. The GPRS sub-system also comprises the Gateway GPRS Support Node (GGSN), which connects to the SGSN via the Gn interface and to external packet data networks (e.g. the Internet) via the Gi interface.

Similarly, all packet data communications from the UE via the E-UTRAN pass through the Evolved Packet Sub-system (EPS). As discussed briefly above, the EPS comprises the SGW and MME, which connect to the E-UTRAN via the S1 interface. To allow packet data interworking for a single UE across multiple types of access networks, the MME and SGW connect to the SGSN via the S3 and S4 interfaces, respectively. The EPS also comprises the Packet Data Gateway (PGW), which provides a gateway from the EPS to external packet data networks (e.g. the Internet). The PGW connects to the SGW via the S5 and S8 interfaces.

Referring again to FIG. 2B, the highest layer of the protocol stack comprises the NAS protocols between the UE and MME. The NAS protocols include EPC mobility management (EMM) procedures, which support user mobility management, and connection management (ECM) procedures, which support user plane bearer activation, modification, and deactivation. For example, the MME creates a UE context when a UE is turned on and attaches to the network. In such case, the MME assigns a unique short temporary identity called the SAE Temporary Mobile Subscriber Identity (S-TMSI) to the UE which identifies the UE context in the MME. This UE context holds user subscription information downloaded from the Home Subscriber Server (HSS) in the user's home network. The HSS subscription information includes the quality-of-service (QoS) profile, any access restrictions for roaming, and information about the packet data networks (PDNs) to which the user may connect. The local storage of subscription data in the MME allows faster execution of procedures such as bearer establishment since it removes the need to for the MME to consult the user's HSS every time. In addition to the HSS information, the UE context also contains dynamic information such as the list of bearers that are currently established and the UE's terminal capabilities.

To reduce the processing in the E-UTRAN and the UE, all UE-related information, including the radio bearers, can be released by the E-UTRAN during long periods of data inactivity. During these periods, known as the idle periods, the MME retains the UE context and the information about the established bearers. To allow the network to contact it as needed, an idle UE updates the network as to its new location whenever it moves out of its current tracking area (TA); this procedure is called a TA update (TAU). The MME is responsible for keeping track of the user location while the UE is idle. When there is a need to deliver downlink data to an idle UE, the MME sends a paging message to all the eNBs in its current TA, and the eNBs page the UE over the radio interface. On receipt of a paging message, the UE performs a Service Request procedure, which moves the UE to the connected state. The MME then updates the UE-related context information and re-establishes the radio bearers in the E-UTRAN. This transition between the UE states is called an idle-to-active transition.

One specific EMM procedure is “attach”, which is initiated by the UE and used to initiate EPC services with the E-UTRAN and to establish an EMM context and a default bearer. In the case the UE wishes to attach for both EPC and non-EPC services (e.g. circuit-switched services such as voice), the UE will initiate a “Combined attach” procedure. Similarly, if the UE wishes to terminate EPC services in the network, it initiates a “detach” procedure or a “combined detach” procedure for terminating both EPC and non-EPC services. Both “detach” procedures also remove the UE's EMM context including releasing all established bearers.

Similarly, a UE may utilize an attach procedure to establish a GPRS mobility management (GMM) context and initiate GPRS services via GERAN or UTRAN. The UE also may utilize a detach procedure to terminate such services (and associated bearers) and to remove the UE's GMM context. These and other GMM procedures are conducted between the UE and the SGSN, which maintains the UE's GPRS context.

Once the UE has established an EMM context, it uses a “Tracking Area Update” (TAU) procedure to update the registration of its tracking area in the network. This may be done when it enters a tracking area in which it has not registered before, or periodically at the request of the network. The TAU procedure may be used by the UE to indicate various other conditions, as defined in 3GPP TS 24.301, including when the UE network capability information or MS network capability information (or both) changes. In the event that the UE is attached for both EPC and non-EPC services, as discussed above, it may utilize a “Combined TAU” procedure to update registration for both types of services.

Similarly, both GERAN and UTRAN include the concept of a “location area”, which uniquely describes a group of base stations in a network. A UE performs a “location area update” (LAU) procedure upon the occurrence of various conditions similar to those that trigger a TAU, including change of actual location area and/or capabilities. Both GERAN and UTRAN also include “routing areas” which are used by UEs that are attached for GPRS services. Various conditions will trigger such devices to perform a “routing area update” (RAU). Devices attached via a GERAN or UTRAN for both GPRS and non-GPRS (e.g. voice) services may need to perform both an LAU and a RAU, which is known as a “combined RAU”.

According to 3GPP TS 24.301, one reason for the UE registered for EPS services to send a TAU request is to update certain UE specific parameters stored in the UE context. For example, the UE will send a TAU request when at least one of the UE network capability information or the MS network capability information changes. The UE network capability information relates to how the UE interworks with the EPS via E-UTRAN or with GPRS via UTRAN, including supported security, encryption, and integrity algorithms. The MS network capability information similarly relates to how the UE interworks with GPRS via GERAN. The UE may also report change in certain capabilities by including its Mobile Classmark information in the TAU request. The Mobile Classmark includes various information such as support for different radio access technologies (i.e. GSM, UMTS, LTE) and frequency bands supported for each technology.

Similarly, as defined in 3GPP TS 24.008, a UE registered for GPRS services also may update its GMM context by sending a RAU (or combined RAU) request via a GERAN or UTRAN. For example, the MS or UE will send a RAU when its MS network capability information (discussed above) or MS Radio Access Capability changes. The MS Radio Access Capability indicates support for different radio access technologies (i.e. GSM, UMTS, LTE), frequency bands, features, and feature packages. The MS or UE also may include the Mobile Classmark and/or UE network capability information (both discussed above) in a RAU request to indicate additional information about its capabilities.

The complete set of radio access technologies (RATs) natively supported by a particular UE is determined at the time of manufacture and does not change. Normally, when the UE attempts to attach to a particular network for services, for example, to an E-UTRAN for EPS services, it indicates its complete native set of RATs to the network in the attach request. In some cases, however, the user may force the UE to use less than the complete native set of RATs during operation. This capability may be provided to the user, for example, by a menu selection in the UE. In other cases, an application executing within the UE may force the UE to use less than the complete native set of RATs. In other cases, the network to which the UE is attached may force the UE to use less than the complete set of native RATs. In any event, this so-called forced system selection (FSS) may occur after the UE has attached for services.

For example, when a UE attaches via an E-UTRAN for EPS services, it may indicate native support for GSM, UMTS, and LTE RATs. Subsequently, however, the user (or an application) may selectively force the UE to use GSM and UMTS RATs but not LTE. As specified by 3GPP TS 24.008 and described previously, the UE attempts to inform the network of the change in capabilities by sending a RAU (or combined RAU) request to change its GMM context to indicate support for GSM and UMTS but not for LTE.

Due to the difference between the UE's previous and new sets of capabilities, however, the network may reject the UE's RAU request, e.g. for security reasons. It has been observed that in the case of such rejections, the network responds with a RAU rejection with cause number 111, indicating an unspecified protocol error. After receiving the RAU rejection, the UE sets its RAU attempt counter to five (5), starts timer T3302, and waits until the timer expires before attempting another RAU request. The UE will receive the same RAU rejection upon subsequent attempts, which causes it to repeat the same post-rejection sequence. Accordingly, the UE may be stuck in an endless sequence of attempting to update its GMM context, during which it is unable to send or receive user data.

Likewise, a user may have previously configured a UE such that when it attaches to a network for services, the UE indicates support for less than its complete set of natively supported RATs. For example, when a UE that natively supports GSM, UMTS, and LTE attaches to a UTRAN for GPRS services, it may indicate that it supports only GSM and UMTS RATs. Subsequently, however, the user, an application in the UE, or the network may reconfigure the UE to use its LTE capabilities instead of, or in addition to, GSM and UMTS. As specified by 3GPP TS 24.301 and described previously, the UE attempts to inform the network of the change in capabilities by sending a TAU (or combined TAU) request to change its EMM context to indicate support for LTE instead of, or in addition to, support for GSM and UMTS.

Due to the difference between the UE's previous and new sets of capabilities, however, the network may reject the UE's TAU request, e.g. for security reasons. It has been observed that in case of such rejections, the network responds with a TAU rejection with cause number 95, indicating a semantically incorrect message. After receiving the TAU rejection with this cause, the UE sets its TAU attempt counter to five (5), starts timer T3402, and waits until the timer expires before re-attempting the TAU request with the same parameters. The UE will receive the same TAU rejection upon subsequent attempts, which causes it to repeat the same post-rejection sequence. Accordingly, the UE may be stuck in an endless sequence of attempting to update its EMM context, during which it is unable to send or receive user data.

Examples of embodiments of the present disclosure include methods for changing a device from communicating with a first data communication system to communicating with a second data communication system that solve at least these problems and provide additional benefits. In some embodiments, the method includes determining a change in the device's capabilities from a first set to a second set, such that the device's context in the first data communication system is no longer valid, and sending a first message to one of the first and the second data communication systems, the first message comprising information identifying one of the first and second sets. The method further comprises sending a second message that, compared to the first message, is directed to a different one of the first and second data communication systems, comprises information identifying a different one of the first and second sets of capabilities, or both. In some embodiments, the first message comprises a detach request (e.g. a GMM detach) sent to the first data communication system (e.g. GPRS) and the second message comprises an attach request (e.g. an EMM attach) sent to the second data communication system (e.g. EPS). In other embodiments, one or more of the first message and the second message comprises an update request (e.g. RAU or TAU) sent to the second data communication system. In some embodiments, the method further comprises sending a third message comprising an update request, receiving a rejection of the update request, and sending the first message based on determining the cause of the rejection is one of a predetermined group of causes. In some embodiments, the first and second sets comprise radio access technologies (RATs) supported by the device, and one of the first and second sets comprises at least one RAT not included in the other set. In some embodiments, the at least one RAT not included in the other set comprises LTE. Embodiments include devices and computer-readable media embodying one or more of the above methods.

Examples of embodiments also include a method for a network equipment to change a device (e.g. a UE) from communicating with a first data communication system to communicating with a second data communication system. The method comprises receiving an update request from the device, determining that the update request comprises information indicating a change in the device's capabilities relative to the device's stored context, and determining which additional action is required. In some embodiments, the method comprises determining to detach the device from the first data communication system due to the change in capabilities, sending a detach request to the device, and removing the device's stored context. In some embodiments, the method comprises determining that the update request must be rejected due to the change in capabilities, sending a rejection to the device indicating the cause as the change in capabilities, receiving a detach request from the device, and removing the device's stored context. The method further comprises receiving an attach request from the device comprising the device's new capabilities and establishing a new context for the device that allows the device to communicate via the second data communication system. Embodiments include network equipment and computer-readable media embodying one or more of the above methods.

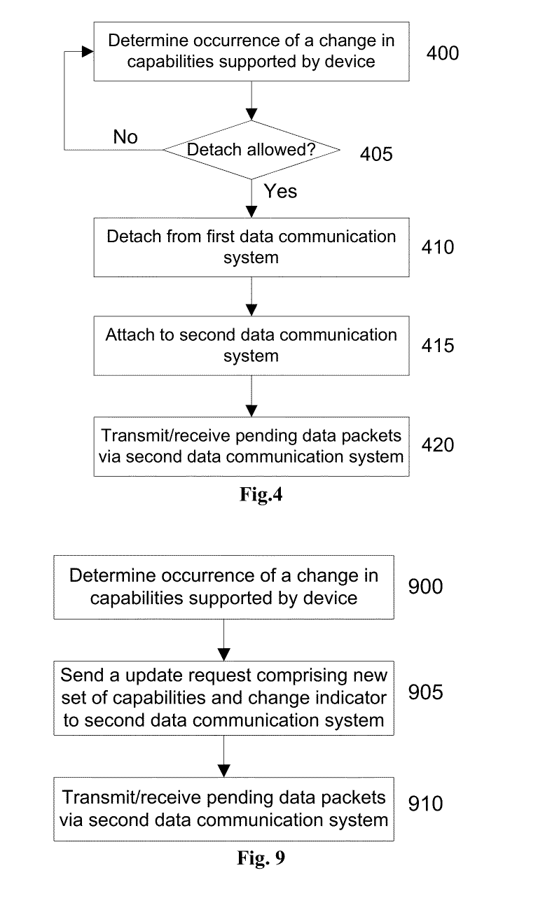

FIGS. 4 to 10 show exemplary methods for changing a communication device (e.g. a UE) from communicating with a first data communication system to communicating with a second data communication system, according to one or more embodiments of the present disclosure. Although each of the figures illustrates a particular method by blocks arranged in a specific order, this order is merely exemplary and the steps of each method may be performed in a different order than shown in the respective figures. Moreover, a person of ordinary skill will understand that the blocks of each method may be combined and/or divided into blocks having different functionality.

FIG. 4 shows a flowchart of an exemplary method for a communication device (e.g. a UE) to change from communicating with a first data communication system to communicating with a second data communication system, according to one or more embodiments of the present disclosure. In block 400, the device determines the occurrence of a change in the capabilities that it supports. The change in capabilities may comprise addition and/or removal of capabilities from the set of capabilities that were previously supported by the device. In other words, the new set of capabilities may comprise capabilities not found in the previous set of capabilities supported by the device, and the previous set of capabilities may comprise capabilities not found in the new set of capabilities. In some embodiments, the change in capabilities may comprise a change in the radio access technologies (RATs) or radio access networks (RANs) supported by the device. In some embodiments, the change in RATs (RANs) supported by the device may comprise addition and/or removal of support for one of LTE (E-UTRAN), GSM (GERAN), and UMTS (UTRAN). In some embodiments, the device determines the occurrence of a change in capabilities by receiving an indication of a user input related to the device capabilities, such as indication of a menu selection via the device's user interface.

In block 405, the device determines if it is permitted to detach from the network to which it is currently attached. For example, the device may be prohibited from detaching from the current network because it is attached for purposes of emergency services. Even in cases where detach is not strictly prohibited, it may not be desirable since it causes the radio connection with the network to be disconnected or “reset”. In such cases, the device may not be permitted to detach without receiving additional information, e.g. a confirmation input from a user or an application executing on the device. In such embodiments, the operations of block 405 comprises receiving and acting upon such additional information. In any event, if the device determines in block 405 that it is not permitted to detach, it returns to block 400 where the device waits to determine a subsequent change in its capabilities or proceeds to apply a different capability change method such as other embodiments described herein. On the other hand, if the device determines that it is allowed to detach, it proceeds to block 410. Note that block 405 is an optional operation, such that in some embodiments, the method shown in FIG. 4 proceeds directly from block 400 to block 410.

In block 410, the device sends a detach request to the first data communication system, i.e. the one to which it is currently attached. In some embodiments, the detach request may comprise the device's previous set of capabilities, i.e. the capabilities before the change detected in block 400. In some embodiments, the first data communication system is a GPRS system, in which case the detach request is part of a GMM detach procedure. In other embodiments, the first data communication system is an EPS, in which case the detach request is part of an EMM detach procedure. In any case, the device successfully detaches from the first communication system in block 410.

Subsequently, in block 415, the device sends an attach request to the second data communication system, i.e. the one to which wishes to attach. In some embodiments, the attach request may comprise the device's new set of capabilities. In some embodiments, the second data communication system is a GPRS system, in which case the attach request is part of a GMM attach procedure. In other embodiments, the second data communication system is an EPS, in which case the attach request is part of an EMM attach procedure. In any case, the device successfully attaches to the second communication system in block 415, and establishes a context comprising its new set of capabilities. The operation in block 415 may comprise establishing a radio access network (RAN) connection based on the device's new set of capabilities (e.g. an LTE connection with an E-UTRAN). In block 420, the device transmits and/or receives any pending packet data traffic via the second data communication system and the connected RAN (e.g. via EPS and the E-UTRAN).

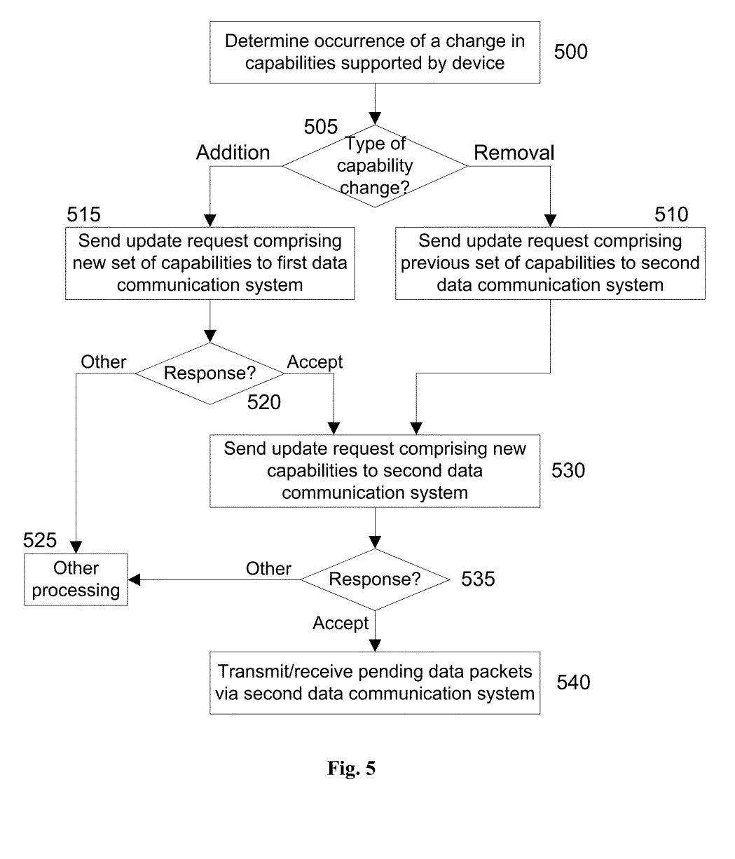

FIG. 5 shows a flowchart of another exemplary method for a communication device (e.g. a UE) to change from communicating with a first data communication system to communicating with a second data communication system, according to one or more embodiments of the present disclosure. In block 500, the device determines the occurrence of a change in the capabilities that it supports, in the manner described above with respect to block 400. The change in capabilities may comprise addition or removal of capabilities from the set of capabilities that were previously supported by the device. In other words, the previous set of capabilities may comprise capabilities not found in the new set of capabilities supported by the device, or the new set of capabilities may comprise capabilities not found in the previous set of capabilities. In some embodiments, the change in capabilities may comprise a change in the radio access technologies (RATs) or radio access networks (RANs) supported by the device. In some embodiments, the change in RATs supported by the device may comprise addition or removal of support for one of LTE (E-UTRAN), GSM (GERAN), and UMTS (UTRAN). In some embodiments, the device determines the occurrence of a change in capabilities by receiving an indication of a user input related to the device capabilities, such as indication of a menu selection via the device's user interface.

In block 505, the device determines the type of capabilities change that was detected in block 500. If the device determines that the capabilities change is a removal of capabilities (i.e. previous set comprises capabilities not found in new set), the device proceeds to block 510 where it sends an update request to the second data communication system, i.e. the one to which it wishes to communicate according to the new set of capabilities. The update request sent in block 505 comprises the device's previous set of capabilities, i.e. the capabilities before the change that was detected in block 500. In some embodiments, the second data communication system is a GPRS system, in which case the update request is part of a GMM routing area update (RAU) or combined RAU procedure. In other embodiments, the second data communication system is an EPS, in which case the update request is part of an EMM tracking area update (TAU) or combined TAU procedure. In any event, the device successfully performs an update in block 510, such that it is attached to the second data communication system with a context comprising the previous set of capabilities.

On the other hand, if the device determines in block 505 that the capabilities change is an addition of capabilities (i.e. new set comprises capabilities not found in previous set), the device proceeds to block 515 where it sends an update request to the first data communication system comprising the device's new set of capabilities, i.e. the capabilities after the change that was detected in block 500. In some embodiments, the first data communication system is a GPRS system, in which case the update request is part of a GMM routing area update (RAU) or combined RAU procedure. In other embodiments, the first data communication system is an EPS, in which case the update request is part of an EMM tracking area update (TAU) or combined TAU procedure. In block 520, the device determines whether the response received to the update request sent in block 515 was an accept or another type of response. If the device determines that the response was an accept, it has successfully performed an update in block 515 such that it is attached to the first data communication system with a context comprising the new set of capabilities. The device then proceeds to block 530.

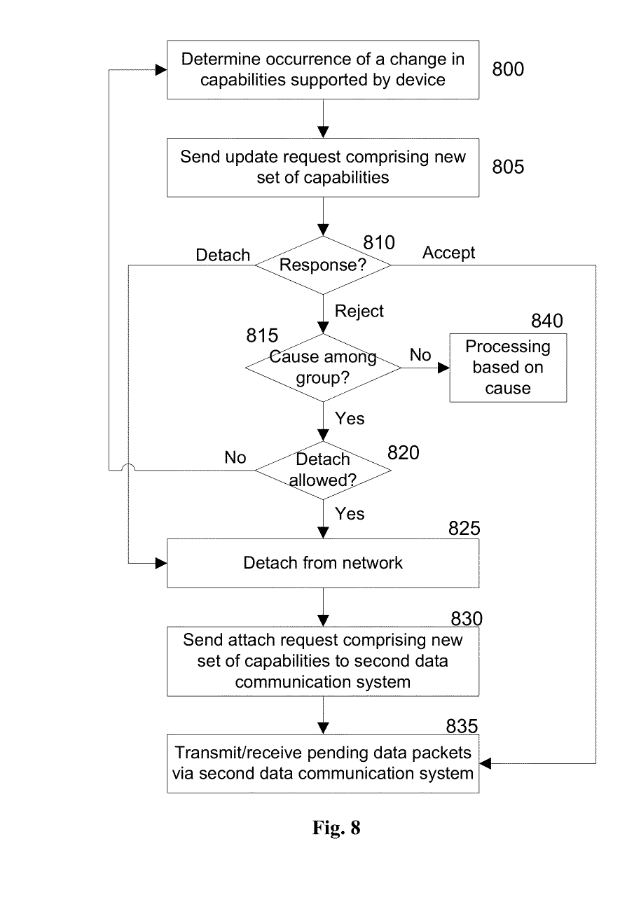

On the other hand, if the device determines in block 520 that another type of response was received (e.g. update reject or detach request), it proceeds to block 525 for other processing appropriate to the type of response received. In some embodiments, the device may proceed to block 610 shown in and described below with reference to FIG. 6, and further to block 615. In other embodiments, the device may proceed to block 810 shown in and described below with reference to FIG. 8, and further to either block 815 or 825 depending on the particular type of non-accept response received.

In block 530, the device sends an update request to the second data communication system, this request comprising the device's new set of capabilities. Depending on whether the device reached block 530 via block 510 or block 515, the device's new set of capabilities sent with the update request in block 530 is a subset or superset of the previous set of capabilities sent in block 505. In block 535, the device determines whether the response received to the update request sent in block 530 was an accept or another type of response. If the device determines that the response was an accept, it has successfully established or updated its context in the second data communication system to comprise the new set of capabilities. In such case, the operations of block 530 and/or 535 may comprise establishing a radio access network (RAN) connection based on the device's new set of capabilities (e.g. a UMTS connection with a UTRAN). The device then proceeds to block 540, where it transmits and/or receives any pending packet data traffic via the second data communication system and the connected RAN (e.g. via GPRS and the UTRAN).

On the other hand, if the device determines in block 535 that another type of response was received (e.g. update reject or detach request), it proceeds to block 525 for other processing appropriate to the type of response received. In some embodiments, the device may proceed to block 615 shown in and described below with reference to FIG. 6. In other embodiments, the device may proceed to block 810 shown in and described below with reference to FIG. 8, and further to either block 815 or 825 depending on the particular type of non-accept response received.

Persons of ordinary skill will recognize that if the new set of capabilities is a superset of the previous set (i.e. the device reached block 520 via block 515), the operations of blocks 520 to 540 may be performed if and when the second data communication system is available to the device. If the second data communication system is not immediately available after block 515 has been completed, the operations of blocks 520 to 540 may be performed at a later time when the second data communication system becomes available (e.g. the device moves into an area where it can communicate with the second system).

FIG. 6 shows a flowchart of another exemplary method for a communication device (e.g. a UE) to change from communicating with a first data communication system to communicating with a second data communication system, according to one or more embodiments of the present disclosure. In block 600, the device determines the occurrence of a change in the capabilities that it supports, in the manner described above with respect to block 400 of FIG. 4. The change in capabilities may comprise removal of capabilities from the set of capabilities that were previously supported by the device. In other words, the previous set of capabilities may comprise capabilities not found in the new set of capabilities supported by the device. In some embodiments, the change in capabilities may comprise a change in the radio access technologies (RATs) or radio access networks (RANs) supported by the device. In some embodiments, the change in RATs (RANs) supported by the device may comprise removal of support for one of LTE (E-UTRAN), GSM (GERAN), and UMTS (UTRAN). In some embodiments, the device determines the occurrence of a change in capabilities by receiving an indication of a user input related to the device capabilities, such as indication of a menu selection via the device's user interface.

In block 605, the device sends an update request comprising the device's new set of capabilities, i.e. the capabilities after the change detected in block 600. In some embodiments, the update request is sent in block 605 to the second data communication system, i.e. the one to which the device wishes to communicate according to the new set of capabilities. In some embodiments, the second data communication system is a GPRS system, in which case the update request is part of a GMM routing area update (RAU) or combined RAU procedure. In other embodiments, the second data communication system is an EPS, in which case the update request is part of an EMM tracking area update (TAU) or combined TAU procedure.

In block 610, the device determines if the update request was rejected by the second data communication system, e.g. GPRS or EPS. If the update request was not rejected (e.g. accepted), the device has established a context comprising the new set of capabilities with the second data communication system, in which case the device proceeds to block 625 where it transmits and/or receives any pending packet data traffic via the second data communication system and the connected RAN (e.g. via GPRS and the UTRAN). On the other hand, if the device determines in block 610 that the update request was rejected, then it proceeds to block 615 where it determines whether the cause of the rejection was among a predetermined group of one or more causes. If the cause was not among the predetermined group, then the device proceeds to block 635 where it processes the rejection according to any existing protocol for the particular cause. If the device determines in block 615 that the cause was among the predetermined group, then it proceeds to block 620 where it sends an update request to the second data communication system, this request comprising the device's previous set of capabilities. Accordingly, the device successfully performs an update in block 620, such that it is attached to the second data communication system with a context comprising the previous set of capabilities.

In block 625, the device sends another update request to the second data communication system, this request comprising the device's new set of capabilities. Depending on the embodiment, the device's new set of capabilities sent with the update request in block 625 is a subset or superset of the previous set of capabilities sent in block 605. In some embodiments, the change in capabilities comprises removal or addition of support for one or more RATs (e.g. LTE). Provided that the update request is not rejected for some unrelated cause, the device successfully updates its context in block 625 to comprise the new set of capabilities. The operation in block 625 may comprise establishing a radio access network (RAN) connection based on the device's new set of capabilities (e.g. a UMTS connection with a UTRAN). In block 630, the device transmits and/or receives any pending packet data traffic via the second data communication system and the connected RAN (e.g. via GPRS and the UTRAN).

In some embodiments, the operations of block 610 and 615 may be performed in conjunction with operations described above with reference to blocks of other figures. For example, the operation of block 610 may comprise determining whether the response received in block 520 or block 535 of FIG. 5 comprises a reject. If it does, then block 615 may comprise determining whether the response received in block 520 or block 535 of FIG. 5 comprises a reject cause among a predetermined group. Further operations of FIG. 8 proceed based on one or more of these determinations in the same manner as described above.

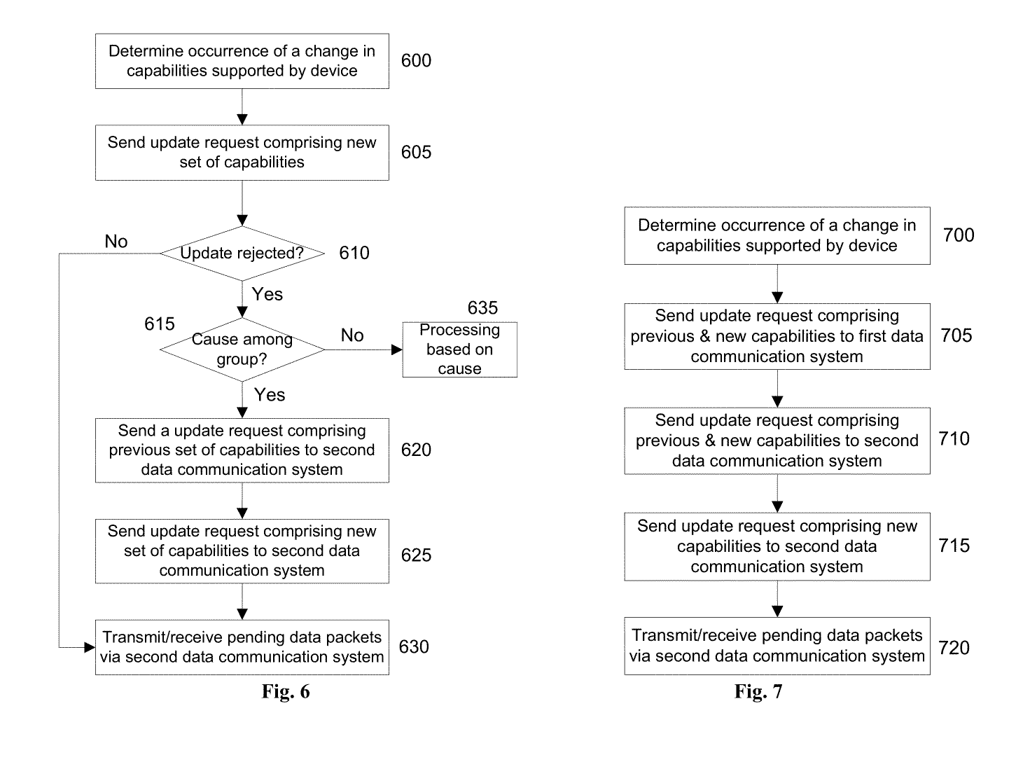

FIG. 7 shows a flowchart of another exemplary method for a communication device (e.g. a UE) to change from communicating with a first data communication system to communicating with a second data communication system, according to one or more embodiments of the present disclosure. In block 700, the device determines the occurrence of a change in the capabilities that it supports, in the manner described above with respect to block 400 of FIG. 4. The change in capabilities may comprise addition of capabilities to the set of capabilities that were previously supported by the device. In other words, the new set of capabilities may comprise capabilities not found in the previous set of capabilities supported by the device, and the previous set of capabilities may comprise capabilities not found in the new set. In some embodiments, the change in capabilities may comprise a change in the radio access technologies (RATs) or radio access networks (RANs) supported by the device. In some embodiments, there is no overlap between the set of RATs/RANs supported in the new capabilities and the set of RATs/RANs supported in the previous capabilities. For example, LTE (E-UTRAN) may be supported in one set of capabilities but not in the other set of capabilities. In some embodiments, the device determines the occurrence of a change in capabilities by receiving an indication of a user input related to the device capabilities, such as indication of a menu selection via the device's user interface.

In block 705, the device sends an update request to the first data communication system, i.e. the one to which it is currently attached. The update request sent in block 705 comprises both the device's new set of capabilities and the device's previous set of capabilities, for which the difference was detected in block 700. In some embodiments, the first data communication system is a GPRS system, in which case the update request is part of a GMM routing area update (RAU) or combined RAU procedure. In other embodiments, the first data communication system is an EPS, in which case the update request is part of an EMM tracking area update (TAU) or combined TAU procedure. In any event, the device successfully performs an update in block 705, such that it is attached to the first data communication system with a context comprising both the new and the previous sets of capabilities.

In block 710, the device sends an update request to the second data communication system, i.e. the one to which it wishes to communicate according to the new set of capabilities. The update request sent in block 710 comprises both the device's new set of capabilities and the device's previous set of capabilities. In some embodiments, the second data communication system is a GPRS system, in which case the update request is part of a GMM routing area update (RAU) or combined RAU procedure. In other embodiments, the second data communication system is an EPS, in which case the update request is part of an EMM tracking area update (TAU) or combined TAU procedure. In any event, the device successfully performs an update in block 710, such that it is attached to the second data communication system with a context comprising both the new and the previous sets of capabilities.

Subsequently, in block 715, the device sends an update request to the second data communication system. The update request sent in block 715 comprises the device's new set of capabilities. In some embodiments, the second data communication system is a GPRS system, in which case the update request is part of a GMM routing area update (RAU) or combined RAU procedure. In other embodiments, the second data communication system is an EPS, in which case the update request is part of an EMM tracking area update (TAU) or combined TAU procedure. In any event, provided that the update request is not rejected for some unrelated cause, the device successfully updates its context in block 715 to comprise the new set of capabilities. The operation in block 715 may comprise establishing a radio access network (RAN) connection based on the device's new set of capabilities (e.g. an LTE connection with an E-UTRAN). In block 720, the device transmits and/or receives any pending packet data traffic via the second data communication system and the connected RAN (e.g. via EPS and the E-UTRAN).

FIG. 8 is a flowchart of another exemplary method for a communication device (e.g. a UE) to change from communicating with a first data communication system to communicating with a second data communication system, according to one or more embodiments of the present disclosure. In block 800, the device determines the occurrence of a change in the capabilities that it supports, in the manner described above with respect to block 400 of FIG. 4. The change in capabilities may comprise addition and/or removal of capabilities from the set of capabilities that were previously supported by the device. In other words, the new set of capabilities may comprise capabilities not found in the previous set of capabilities supported by the device and vice versa. In some embodiments, the change in capabilities may comprise a change in the radio access technologies (RATs) or radio access networks (RANs) supported by the device. In some embodiments, the change in RATs (RANs) supported by the device may comprise addition and/or removal of support for one of LTE (E-UTRAN), GSM (GERAN), and UMTS (UTRAN). In some embodiments, the device determines the occurrence of a change in capabilities by receiving an indication of a user input related to the device capabilities, such as indication of a menu selection via the device's user interface.

In block 805, the device sends an update request comprising the device's new set of capabilities, i.e. the capabilities after the change detected in block 800. In some embodiments, the update request is sent in block 805 to the second data communication system, i.e. the one to which the device wishes to communicate according to the new set of capabilities. In some embodiments, the second data communication system is a GPRS system, in which case the update request is part of a GMM routing area update (RAU) or combined RAU procedure. In other embodiments, the second data communication system is an EPS, in which case the update request is part of an EMM tracking area update (TAU) or combined TAU procedure.

In block 810, the device determines the response received to the update request sent in block 805. If the device determines that update request was accepted (e.g. a RAU/TAU accept message was received indicating that device's context has been updated to the new capabilities), the device proceeds to block 835 where it transmits and/or receives any pending packet data traffic via the second data communication system and the connected RAN (e.g. via GPRS and the UTRAN). Alternatively, if the device determines in block 810 that the response is a detach request, it proceeds to block 825 where detaches from the network by, for example, by sending a detach accept and performing other actions specified in relevant 3GPP standards. In various embodiments, the operation of block 825 may be performed with respect to the first or the second data communication system. In some embodiments, the data communication system is a GPRS system, in which case the detach accept is part of a GMM detach procedure. In other embodiments, the data communication system is an EPS, in which case the detach accept is part of an EMM detach procedure. In some embodiments, the operation performed in block 825 may be a local-type of detach that involves no signaling with the network. In any case, the device successfully detaches from the network in block 825.

If the device determines instead in block 810 that the response received was a rejection of the update request, then it proceeds to block 815 where it determines whether the cause of the rejection was among a predetermined group of one or more causes. If the cause was not, then the device proceeds to block 840 where it processes the rejection according to any existing protocol for the particular cause. However, if the device determines in block 815 that the cause was among the predetermined group, then it proceeds to block 820 where the device determines if it is permitted to detach from the network to which it is currently attached. For example, the device may be prohibited from detaching from the current network because it is attached for purposes of emergency services. Even in cases where detach is not strictly prohibited, it may not be desirable since it causes the radio connection with the network to be disconnected or “reset”. In such cases, the device may not be permitted to detach without receiving additional information, e.g. a confirmation input from a user or an application executing on the device. In such embodiments, the operations of block 820 comprises receiving and acting upon such additional information.

In any event, if the device determines that it is not permitted to detach, it returns to block 800 where it waits to determine a subsequent change in its capabilities or proceeds to apply a different capability change method such as other embodiments described herein. If the device determines that it is allowed to detach, it proceeds to block 825. Note that block 820 is an optional operation, such that in some embodiments, the method shown in FIG. 8 proceeds directly from block 815 to block 825. In block 825, the device detaches from the network by, for example, sending a detach accept and performing other actions specified in relevant 3GPP standards. In various embodiments, the operation of block 825 may be performed with respect to the first or the second data communication system. In some embodiments, the data communication system is a GPRS system, in which case the detach accept is part of a GMM detach procedure. In other embodiments, the data communication system is an EPS, in which case the detach accept is part of an EMM detach procedure. In some embodiments, the operation performed in block 825 may be a local-type of detach that involves no signaling with the network. In any case, the device successfully detaches from the network in block 825.

Subsequently, in block 830, the device sends an attach request to the second data communication system, i.e. the one to which wishes to attach. In some embodiments, the attach request may comprise the device's new set of capabilities. In some embodiments, the second data communication system is a GPRS system, in which case the attach request is part of a GMM attach procedure. In other embodiments, the second data communication system is an EPS, in which case the attach request is part of an EMM attach procedure. In any case, the device successfully attaches to the second communication system in block 830, and establishes a context comprising its new set of capabilities. The operation in block 830 may comprise establishing a radio access network (RAN) connection based on the device's new set of capabilities (e.g. an LTE connection with an E-UTRAN). In block 835, the device transmits and/or receives any pending packet data traffic via the second data communication system and the connected RAN (e.g. via EPS and the E-UTRAN).

In some embodiments, the operation of block 810 may be performed in conjunction with operations described above with reference to blocks of other figures. For example, the operation of block 810 may comprise determining whether a non-accept (i.e. “other”) response received in block 520 or block 535 of FIG. 5 comprises a reject or a detach request. Further operations of FIG. 8 proceed based on that determination in the same manner as described above.

FIG. 9 is a flowchart of another exemplary method for a communication device (e.g. a UE) to change from communicating with a first data communication system to communicating with a second data communication system, according to one or more embodiments of the present disclosure. In block 900, the device determines the occurrence of a change in the capabilities that it supports, in the manner described above with respect to block 400 of FIG. 4. The change in capabilities may comprise addition and/or removal of capabilities from the set of capabilities that were previously supported by the device. In other words, the new set of capabilities may comprise capabilities not found in the previous set of capabilities supported by the device and vice versa. In some embodiments, the change in capabilities may comprise a change in the radio access technologies (RATs) or radio access networks (RANs) supported by the device. In some embodiments, the change in RATs (RANs) supported by the device may comprise addition and/or removal of support for one of LTE (E-UTRAN), GSM (GERAN), and UMTS (UTRAN). In some embodiments, the device determines the occurrence of a change in capabilities by receiving an indication of a user input related to the device capabilities, such as indication of a menu selection via the device's user interface.

In block 905, the device sends an update request to the second data communication system, i.e. the one to which it wishes to communicate according to the new set of capabilities. The update request sent in block 905 comprises the device's new set of capabilities, i.e. the capabilities after the change detected in block 900. The update request sent in block 905 also comprises a capabilities changes indicator, which indicates that the sending device has a change in capabilities that renders its current context with the first data communication system invalid. In some embodiments, the capabilities change indicator may indicate that the set of RATs previously supported by the device has changed. In some embodiments, the capabilities change indicator may indicate one of a plurality of capabilities changes, each related to a particular change in RAT support (e.g. removal or addition of support for GERAN, UTRAN, or E-UTRAN). In some embodiments, the second data communication system is a GPRS system, in which case the update request is part of a GMM routing area update (RAU) or combined RAU procedure. In other embodiments, the second data communication system is an EPS, in which case the update request is part of an EMM tracking area update (TAU) or combined TAU procedure.

Provided that the update request is not rejected for some unrelated cause, the device successfully updates its context in block 905 to comprise the new set of capabilities. The operation in block 905 may comprise establishing a radio access network (RAN) connection based on the device's new set of capabilities (e.g. an LTE connection with an E-UTRAN). In block 910, the device transmits and/or receives any pending packet data traffic via the second data communication system and the connected RAN (e.g. via EPS and the E-UTRAN).

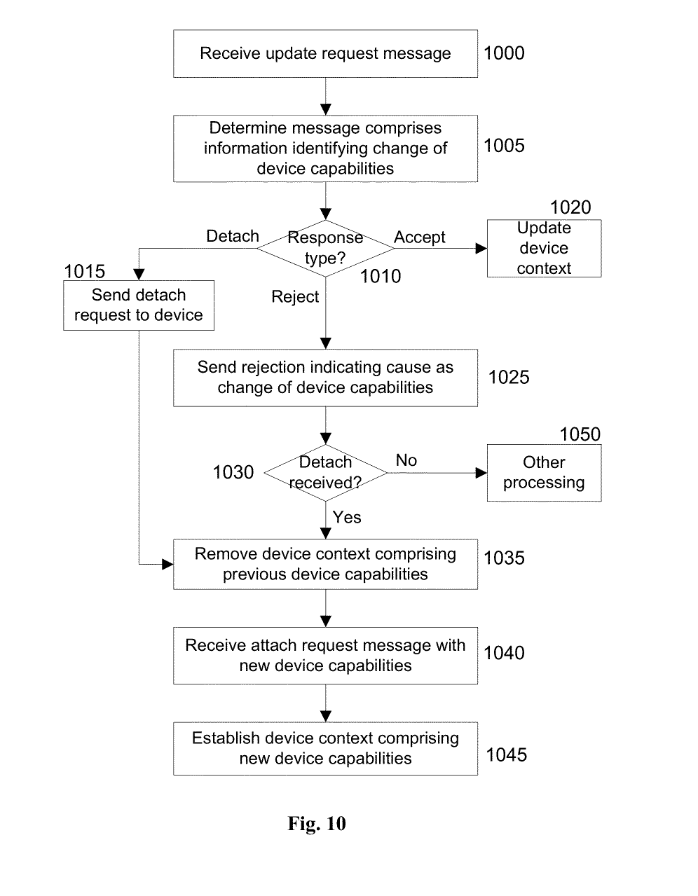

FIG. 10 is a flowchart of an exemplary method for a network equipment to change a device (e.g. a UE) from communicating with a first data communication system to communicating with a second data communication system, according to one or more other embodiments of the present disclosure. In block 1000, the network receives an update request from the communication device, indicating that it wishes to communicate with a second data communication system. In some embodiments, the second data communication system is a GPRS system, in which case the update request is part of a GMM routing area update (RAU) or combined RAU procedure. In other embodiments, the second data communication system is an EPS, in which case the update request is part of an EMM tracking area update (TAU) or combined TAU procedure.

In block 1005, the network determines that the update request comprises information identifying a change in the device's capabilities compared to the set of capabilities that are associated with the device's context currently stored in the network. The change in capabilities may comprise addition and/or removal of capabilities from the set of capabilities that were previously supported by the device. In other words, the new set of capabilities may comprise capabilities not found in the previous set of capabilities supported by the device and vice versa. In some embodiments, the change in capabilities may comprise a change in the radio access technologies (RATs) or radio access networks (RANs) supported by the device. In some embodiments, the change in RATs (RANs) supported by the device may comprise addition and/or removal of support for one of LTE (E-UTRAN), GSM (GERAN), and UMTS (UTRAN).

In block 1010, the network determines what type of response to the update request received in block 1000 should be sent to the requesting device. The network may determine that it should send an update accept to the device, for example, if the network is able to successfully update the device's stored context according to the new set of capabilities provided in the update request. In such case, the network proceeds to block 1020 where it sends an update accept and updates the device's stored context according to the new set of capabilities provided in the update request. Alternatively, the network may determine to reject the update request received in block 1000 due to the change in capabilities relative to the device's stored context. In such case, the network proceeds to block 1025 where it responds to the device with a rejection of the update request, also comprising an indication that the cause of the rejection was the difference in the device's capabilities between the device's stored context and the update request received in block 1000.

Next, in block 1030, the network determines whether it has received a detach request from the device. If not, the network proceeds to block 1050 where it performs other processing, e.g., updating operations with respect to other devices or other mobility management operations with respect to the device or other devices. If the network determines in block 1030 that it has received a detach request from the device, it proceeds to block 1035. In some embodiments, the operations of block 1030 may comprise sending a detach accept to the device.

Alternatively, the network may determine in block 1010 to send a detach request to the device, on the basis of the change between the change in the device's capabilities determined in block 1005. For example, the network may determine to send a detach request to the device on the basis that the particular change in capabilities poses a type of a security risk to entities within the network, that the particular change in capabilities is uncommon or unexpected, or for some other reason. In such case, the network proceeds to block 1015 where it sends a detach request to the device, then on to block 1035. In some embodiments, the operations of block 1015 may comprise receiving a detach accept from the device.

In block 1035, the network removes (e.g. deletes, erases, makes inaccessible, etc.) the device's stored context in response to a detach procedure initiated by either the network or the device. In block 1040, the network receives an attach request from the device, comprising the device's new set of capabilities, which are substantially the same as the capabilities indicated in the update request received in block 1000. In block 1045, the network establishes or creates a new context for the device comprising the new set of capabilities received, which allows the device to communicate via the second data communication system. In some embodiments, the operations in block 1045 may comprise responding to the device with an indication that the attach request was successful.

Although the operation of block 1010 of FIG. 10 has been described above as comprising options for sending either an update reject or a detach request, in some embodiments one of these options may be absent. In such cases, subsequent operations related to the absent option are not used. For example, the network equipment may not utilize an option to send a detach request. In such case, the operations of block 1015 (i.e. sending a detach request) are not used.

In an alternative embodiment, the operation of block 1010 may comprise determining whether to accept or reject the change in capabilities. If the network determines to reject the capability change, it proceeds to block 1025 and then to block 1030 as shown in FIG. 10. If the network determines in block 1030 that no detach request was received from the device, it sends a detach request to the device (block 1015) and then removes the device's stored context comprising the previous capabilities (block 1030). Persons of ordinary skill will recognize that this alternative embodiment is merely exemplary of ways in which the operations of the blocks of FIG. 10 may be rearranged, reordered, recombined, etc.

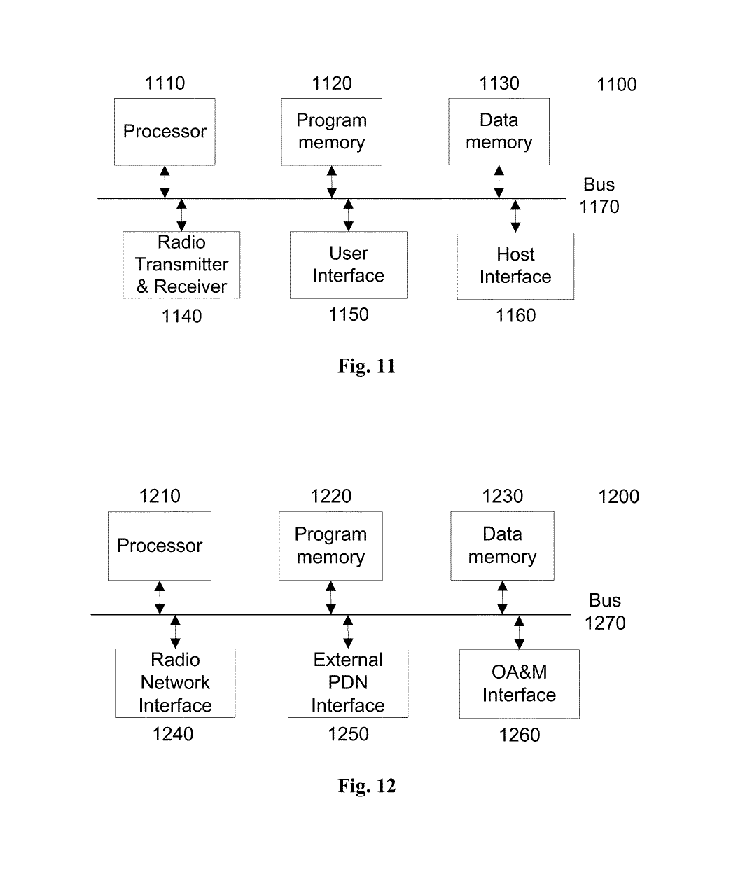

FIG. 11 is a block diagram of an exemplary wireless communication device or apparatus, such as a user equipment (UE) or component or subset of a UE (e.g. modem), utilizing certain embodiments of the present disclosure, including one or more of the methods described above with reference to FIGS. 4 to 10. Device 1100 comprises processor 1110 which is operably connected to program memory 1120 and data memory 1130 via bus 1170, which may comprise parallel address and data buses, serial ports, or other methods and/or structures known to those of ordinary skill in the art. Program memory 1120 comprises software code executed by processor 1110 that enables device 1100 to communicate with one or more other devices using protocols according to various embodiments of the present disclosure, including the LTE PHY protocol layer and improvements thereto, including those described above with reference to FIGS. 6 to 9. Program memory 1120 also comprises software code executed by processor 1110 that enables device 1100 to communicate with one or more other devices using other protocols or protocol layers, such as LTE MAC, RLC, PDCP, and RRC layer protocols standardized by 3GPP, or any improvements thereto; UMTS, HSPA, GSM, GPRS, EDGE, and/or CDMA2000 protocols; Internet protocols such as IP, TCP, UDP, or others known to persons of ordinary skill in the art; or any other protocols utilized in conjunction with radio transceiver 1140, user interface 1150, and/or host interface 1160. Program memory 1120 further comprises software code executed by processor 1110 to control the functions of device 1100, including configuring and controlling various components such as radio transceiver 1140, user interface 1150, and/or host interface 1160. Such software code may be specified or written using any known or future developed programming language, such as e.g. Java, C++, C, and Assembler, as long as the desired functionality, e.g. as defined by the implemented method steps, is preserved.

Data memory 1130 may comprise memory area for processor 1110 to store variables used in protocols, configuration, control, and other functions of device 1100. As such, program memory 1120 and data memory 1130 may comprise non-volatile memory (e.g., flash memory), volatile memory (e.g. static or dynamic RAM), or a combination thereof. Persons of ordinary skill in the art will recognize that processor 1110 may comprise multiple individual processors (not shown), each of which implements a portion of the functionality described above. In such case, multiple individual processors may be commonly connected to program memory 1120 and data memory 1130 or individually connected to multiple individual program memories and or data memories. More generally, persons of ordinary skill in the art will recognize that various protocols and other functions of device 1100 may be implemented in many different combinations of hardware and software including, but not limited to, application processors, signal processors, general-purpose processors, multi-core processors, ASICs, fixed digital circuitry, programmable digital circuitry, analog baseband circuitry, radio-frequency circuitry, software, firmware, and middleware.

Radio transceiver 1140 may comprise radio frequency transmitter and/or receiver functionality that enables device 1100 to communicate with other equipment supporting like wireless communication standards. In an exemplary embodiment, radio transceiver 940 includes an LTE transmitter and receiver that enable device 1100 to communicate with various E-UTRANs according to standards promulgated by 3GPP. In some embodiments, radio transceiver 1140 includes circuitry, firmware, etc. necessary for device 1100 to communicate with network equipment using the LTE PHY protocol layer methods and improvements thereto such as those described above with reference to FIGS. 4 to 9. In some embodiments, radio transceiver 1140 includes circuitry, firmware, etc. necessary for device 1100 to communicate with various UTRANs and GERANs. In some embodiments, radio transceiver 1140 includes circuitry, firmware, etc. necessary for device 1100 to communicate with various CDMA2000 networks.

In some embodiments, radio transceiver 1140 is capable of communicating on a plurality of LTE frequency-division-duplex (FDD) frequency bands 1 to 25, as specified in 3GPP standards. In some embodiments, radio transceiver 1140 is capable of communicating on a plurality of LTE time-division-duplex (TDD) frequency bands 33 to 43, as specified in 3GPP standards. In some embodiments, radio transceiver 1140 is capable of communicating on a combination of these LTE FDD and TDD bands, as well as other bands specified in the 3GPP standards. In some embodiments, radio transceiver 1140 is capable of communicating on one or more unlicensed frequency bands, such as the ISM band in the region of 2.4 GHz. The radio functionality particular to each of these embodiments may be coupled with or controlled by other circuitry in device 1100, such as processor 1110 executing protocol program code stored in program memory 1120.

User interface 1150 may take various forms depending on the particular embodiment of device 1100. In some embodiments, device 1100 is a mobile phone, in which case user interface 1150 may comprise a microphone, a loudspeaker, slidable buttons, depressable buttons, a keypad, a keyboard, a display, a touchscreen display, and/or any other user-interface features commonly found on mobile phones. In other embodiments, device 1100 is a data modem capable of being utilized with a host computing device, such as a PCMCIA data card or a modem capable of being plugged into a USB port of the host computing device. In these embodiments, user interface 1150 may be very simple or may utilize features of the host computing device, such as the host device's display and/or keyboard.

Host interface 1160 of device 1100 also may take various forms depending on the particular embodiment of device 1100. In embodiments where device 1100 is a mobile phone, host interface 1160 may comprise a USB interface, an HDMI interface, or the like. In the embodiments where device 1100 is a data modem capable of being utilized with a host computing device, host interface may be a USB or PCMCIA interface.

In some embodiments, device 1100 may comprise more functionality than is shown in FIG. 11. In some embodiments, device 1100 may also comprise functionality such as a video and/or still-image camera, media player, etc., and radio transceiver 1140 may include circuitry necessary to communicate using additional radio-frequency communication standards including GSM, GPRS, EDGE, UMTS, HSPA, CDMA2000, LTE, WiFi, Bluetooth, GPS, and/or others. Persons of ordinary skill in the art will recognize the above list of features and radio-frequency communication standards is merely exemplary and not limiting to the scope of the present disclosure. Accordingly, processor 1110 may execute software code stored in program memory 1120 to control such additional functionality.

FIG. 12 is a block diagram of exemplary network equipment 1200, utilizing certain embodiments of the present disclosure, including those described above with reference to FIGS. 4 to 10. Although network equipment 1200 is shown in FIG. 12 as a single piece of equipment, this is only for purposes of explanation and illustration, and the person of ordinary skill will understand that the functionality of network equipment 1200 may be spread across multiple pieces of equipment that are communicably coupled. For example, network equipment 1200 may comprise functionality found in various network elements shown in FIG. 3 (e.g. SGSN, MME, E-UTRAN, UTRAN, GERAN) that are communicably coupled via interfaces specified in detail by various 3GPP standards.

Network equipment 1200 comprises one or more processors that are operably connected to one or more program memories and one or more data memories. By way of example, network equipment 1200 comprises processor 1210, which is operably connected to program memory 1220 and data memory 1230 via bus 1270, which may comprise parallel address and data buses, serial ports, or other methods and/or structures known to those of ordinary skill in the art. Program memory 1220 comprises software code executed by processor 1210 that enables network equipment 1200 to communicate with one or more other devices using protocols according to various embodiments of the present disclosure, including 3GPP mobility management protocols (e.g. GMM and EMM) and improvements thereto. Program memory 1220 also comprises software code executed by processor 1210 that enables network equipment 1200 to communicate with one or more other devices using other protocols or protocol layers, such as one or more of the PHY, MAC, RLC, PDCP, and RRC, and/or NAS layer protocols standardized by 3GPP, or any other higher-layer protocols utilized in conjunction with radio network interface 1240 and external packet data network (PDN) interface 1250.

By way of example and without limitation, external PDN interface 1250 may comprise the Gi interface and one or more other interfaces to external packet data networks such as the Internet. External PDN interface 1250 may comprise interfaces standardized by 3GPP, Internet Engineering Task Force (IETF), or other organizations, or one or more interfaces otherwise known by persons of ordinary skill in the art. Radio network interface 1250 may comprise one or more of the Um, Uu, and LTE-Uu interfaces, as standardized by 3GPP. Program memory 1220 further comprises software code executed by processor 1210 to control the functions of network equipment 1200, including configuring and controlling various components such as radio network interface 1240 and external PDN interface 1250.

Data memory 1230 may comprise memory area for processor 1210 to store variables used in protocols, configuration, control, and other functions of network equipment 1200. As such, program memory 1220 and data memory 1230 may comprise non-volatile memory (e.g. flash memory, hard disk, etc.), volatile memory (e.g. static or dynamic RAM), network-based (e.g. “cloud”) storage, or a combination thereof. Persons of ordinary skill in the art will recognize that processor 1210 may comprise multiple individual processors (not shown), each of which implements a portion of the functionality described above. In such case, multiple individual processors may be commonly connected to program memory 1220 and data memory 1230 or individually connected to multiple individual program memories and/or data memories. More generally, persons of ordinary skill in the art will recognize that various protocols and other functions of network equipment 1200 may be implemented in many different combinations of hardware and software including, but not limited to, application processors, signal processors, general-purpose processors, multi-core processors, ASICs, fixed digital circuitry, programmable digital circuitry, analog baseband circuitry, radio-frequency circuitry, software, firmware, and middleware.

Radio network interface 1240 may comprise transmitters, receivers, signal processors, ASICs, antennas, beamforming units, and other circuitry that enables network equipment 1200 to communicate with other equipment such as, in some embodiments, a plurality of compatible UEs. In some embodiments, radio network interface may comprise various protocols or protocol layers, such as the LTE PHY, MAC, RLC, PDCP, and RRC layer protocols standardized by 3GPP, improvements thereto such as described herein with reference to one of more FIGS. 6 to 10, or any other higher-layer protocols utilized in conjunction with radio network interface 1240. In some embodiments, the radio network interface 1240 may comprise a PHY layer based on orthogonal frequency division multiplexing (OFDM), orthogonal frequency division multiple access (OFDMA), code-division multiple access (CDMA), time-division multiple access (TDMA), frequency-division duplexing (FDD), time-division duplexing (TDD) technologies, or a combination thereof.

External PDN interface 1250 may comprise transmitters, receivers, and other circuitry that enables network equipment 1200 to communicate with other equipment in a packet data network such as, in some embodiments, the Internet. In some embodiments, external PDN interface 1250 may comprise the Gi interface standardized by 3GPP. In some embodiments, external PDN interface 1250 may comprise other interfaces that are standardized or otherwise known to persons of ordinary skill in the art. In some embodiments, these one or more interfaces may be multiplexed together on a single physical interface. In some embodiments, lower layers of external PDN interface 1250 may comprise one or more of asynchronous transfer mode (ATM), Internet Protocol (IP)-over-Ethernet, SDH over optical fiber, T1/E1/PDH over a copper wire, microwave radio, or other wired or wireless transmission technologies known to those of ordinary skill in the art.

OA&M interface 1260 may comprise transmitters, receivers, and other circuitry that enables network equipment 1200 to communicate with external networks, computers, databases, and the like for purposes of operations, administration, and maintenance of network equipment 1200 or other network equipment operably connected thereto. Lower layers of OA&M interface 1260 may comprise one or more of asynchronous transfer mode (ATM), Internet Protocol (IP)-over-Ethernet, SDH over optical fiber, T1/E1/PDH over a copper wire, microwave radio, or other wired or wireless transmission technologies known to those of ordinary skill in the art. Moreover, in some embodiments, one or more of radio network interface 1240, external PDN interface 1250, and OA&M interface 1260 may be multiplexed together on a single physical interface, such as the examples listed above.

In an exemplary embodiment of the first exemplary embodiment of the invention described above, the method comprises determining whether the device is permitted to detach from the first data communication system, wherein sending the first message is conditioned upon determining that the device is permitted to detach.

In an exemplary embodiment of the first exemplary embodiment of the invention described above, the method comprises receiving a user input relating to the device's capabilities.

In an exemplary embodiment of the first exemplary embodiment of the invention described above, the change in the device's capabilities is caused by an application executed by the device.

In an exemplary embodiment of the third exemplary embodiment of the invention described above, the apparatus is arranged to cause the apparatus to receive a third message from the device; the second message comprises a rejection and information identifying the change in the device's capabilities from the first set to the second set as the rejection cause; the third message comprises a detach request; the fourth message comprises an attach request; and the apparatus is arranged to cause the apparatus to remove the device's context in response to receiving the third message.

In an exemplary embodiment of the third exemplary embodiment of the invention described above, the second message comprises a detach request; the fourth message comprises an attach request; and the apparatus is arranged to remove the device's context in association with sending the second message.

In an exemplary embodiment of the third exemplary embodiment of the invention described above, the first data communication system is a General Packet Radio Service (GPRS) system; the second data communication system is an Evolved Packet System (EPS); the first message is one of a routing area update (RAU) request and a combined RAU request; and the change in the device's capabilities comprises the addition of support for Long Term Evolution (LTE) radio access technology.

In an exemplary embodiment of the third exemplary embodiment of the invention described above, the first data communication system is an Evolved Packet System (EPS); the second data communication system is a General Packet Radio Service (GPRS) system; the first message is one of a tracking area update (TAU) request and a combined TAU request; and the change in the device's capabilities comprises the removal of support for Long Term Evolution (LTE) radio access technology.

In an exemplary embodiment of the third exemplary embodiment of the invention described above, the apparatus comprises one or more of an SGSN, an MME, a GERAN, a UTRAN, and an E-UTRAN.

As described herein, a device or apparatus may be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. A device or apparatus may be regarded as a device or apparatus, or as an assembly of multiple devices and/or apparatus, whether functionally in cooperation with or independently of each other. Moreover, devices and apparatus may be implemented in a distributed fashion throughout a system, so long as the functionality of the device or apparatus is preserved. Such and similar principles are considered as known to a skilled person.

More generally, even though the present disclosure and exemplary embodiments are described above with reference to the examples according to the accompanying drawings, it is to be understood that they are not restricted thereto. Rather, it is apparent to those skilled in the art that the disclosed embodiments can be modified in many ways without departing from the scope of the disclosure herein. Moreover, the terms and descriptions used herein are set forth by way of illustration only and are not meant as limitations. Those skilled in the art will recognize that many variations are possible within the spirit and scope of the disclosure as defined in the following claims, and their equivalents, in which all terms are to be understood in their broadest possible sense unless otherwise indicated.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method for changing a communication device from communicating with a first data communication system to communicating with a second data communication system, the method comprising:
determining a change in the device's capabilities from a first set to a second set, such that the device's context in the first data communication system is no longer valid;
sending a first message to one of the first and the second data communication systems; and
sending a second message, wherein the second message is at least one of the following relative to the first message: directed to a different one of the first and second data communication systems, and comprising different device capability information.

2. A method according to claim 1, wherein:
the first message comprises a detach request and is sent to the first data communication system; and
the second message comprises an attach request and is sent to the second data communication system.

3. A method according to claim 2, wherein the second message comprises information identifying the second set.

4. A method according to claim 1, wherein the first and second messages comprise update requests.

5. A method according to claim 4, wherein:
the first set comprises capabilities not included in the second set; and
the first and second messages are sent to the second data communication system.

6. A method according to claim 5, wherein the first message comprises information identifying the first set.

7. A method according to claim 5, comprising sending a third message comprising an update request, wherein both the first and the third messages comprise information identifying the second set.

8. A method according to claim 4, wherein:
the first message is sent to the first data communication system; and
the second message is sent to the second data communication system.

9. A method according to claim 8, wherein the second set comprises capabilities not included in the first set.

10. A method according to claim 8, comprising sending a third message comprising an update request, wherein both the first and second messages comprise information identifying both the first and second sets of capabilities.

11. A method according to claim 2, comprising:
sending a third message comprising an update request; and
receiving a rejection of the update request comprising information identifying the cause of the rejection;
determining whether the cause of the rejection is one of a predetermined group of causes;
sending the first message in response to determining that the cause of the rejection is one of the predetermined group of causes.

12. A method according to claim 11, wherein the predetermined group of causes comprises at least one of (i) an unexpected change in device's capabilities and (ii) an abnormal update request.

13. A method according to claim 11, wherein the predetermined group of causes comprises all causes that do not require waiting until the expiration of a delay timer before sending the first message.

14. A method according to claim 1, wherein the change comprises one of removing support for one or more radio access technologies (RATs) and adding support for one or more RATs.

15. A method according to claim 14, wherein the one or more RATs comprises Long Term Evolution (LTE), the first data communication system is one of General Packet Radio Service (GPRS) and Evolved Packet System (EPS), and the second data communication system is the other of GPRS and EPS than the first data communication system.

16. Apparatus comprising:
at least one processor;
and at least one memory including computer program code;
the at least one memory and the computer program code being configured to, with the at least one processor, cause the apparatus at least to:
determine a change in the apparatus capabilities from a first set to a second set, such that the apparatus context in a first data communication system is no longer valid;
send a first message to one of the first data communication system and a second data communication systems; and
send a second message, wherein the second message is at least one of the following relative to the first message: directed to a different one of the first and second data communication systems, and comprising different device capability information.

17. Apparatus according to claim 16, wherein:
the first message comprises a detach request and is sent to the first data communication system; and
the second message comprises an attach request and is sent to the second data communication system.

18. Apparatus according to claim 17, wherein the second message comprises information identifying the second set.

19. Apparatus according to claim 16, wherein the first and second messages comprise update requests.

20. Apparatus, comprising:
at least one processor;
and at least one memory including computer program code;
the at least one memory and the computer program code being configured to, with the at least one processor, cause the apparatus at least to:
receive a first message from a communication device;
determine that the first message comprises a second set of the device's capabilities that is different from a first set of the device's capabilities comprising the device's context in a first data communication system;
send a second message to the device;
remove the device's context in the first communication system;
receive a fourth message from the device comprising the second set of capabilities; and
establish a new context for the device based on the fourth message, wherein the new context allows the device to communicate via a second data communication system.
